(19) United States
(12) Patent Application Publication
(10) Pub. No.: US 2005/0266179 A1
(43) Pub. Date: Dec. 1, 2005

(54) Camouflage composition and method of making

(76) Inventor: Scott S. Shultz, Cannon Falls, MN (US)

Correspondence Address: Patterson, Thuente, Skaar & Christensen, P.A., 4800 IDS Center, 80 South 8th Street, Minneapolis, MN, 55402-2100, US

(21) Appl. No.: 11/175,116

(22) Filed: Jul. 5, 2005

Related U.S. Application Data
(63) Continuation of application No. 10/131,579, filed on Apr. 24, 2002.

(51) Int. Cl. B44F 9/00; D03D 1/00

(52) U.S. Cl. 428/17; 442/181; 428/15

(57) ABSTRACT

A composite camouflage composition includes a substrate and a plurality of individual strips of camouflage material being spaced apart and adhered to the substrate along a bonding axis, each strip of the plurality of individual strips of camouflage material presenting a plurality of lobes adjacent the bonding axis, each strip of the plurality of individual strips of camouflage material being gathered at points along the bonding axis such that more than one layer of each strip of the plurality of individual strips of camouflage material is adhered to the substrate at such points. A garment and a method of forming the camouflage composition is further included.

### RELATED APPLICATION

This application is a Continuation of application Ser. No. 10/131,579 filed Apr. 24, 2002, which is hereby incorporated by reference.

### TECHNICAL FIELD

The present invention relates to camouflage materials for forming camouflage net systems, garments and the like. More particularly, the present invention relates to a camouflage composition that has a three-dimensional (3-D) appearance.

### BACKGROUND OF THE INVENTION

Camouflage materials have long been employed to conceal objects, personnel, and equipment in various terrains from visual detection. Generally, such camouflage materials for concealing objects and equipment are drapable two-dimensional sheets or net structures of varying size and shape, and are solid color or imprinted in multiple color patterns. For concealing personnel, such camouflage materials are formed into a plurality of different garments including, but not limited to: jackets, pullovers, parkas, coveralls, bibs, and pants.

In recent years, in an effort to enhance concealment, efforts have been directed toward adding a third dimension to such camouflage materials. To that end, two companion patents, U.S. Pat. Nos. 4,931,320 and 5,013,375, both to Robert R. Leonard, are directed to a camouflage material (the '320 patent) and to a method and apparatus for producing the material (the '375 patent).

The aforementioned material is a camouflage construction having an open mesh net substrate, and a continuous sheet overlying the substrate and bonded thereto along plural spaced lines of attachment. The sheet is cut on opposite sides of the lines of attachment to form a plurality of lobes. The apparatus and method includes a sewing station for stitching the sheet along plural spaced lines of attachment to the substrate to form open-ended pockets for channels between the sheet and substrate. The cutting station spaces the sheet from the substrate and a heated cutting wire reciprocates between adjacent lines of stitches to cut the sheet and open the channel to form a series of loose lobes. A problem with such construction is that the lobes were cut from an essentially flat, two-dimensional material having a substantially flat set to the material. Notwithstanding the fact that the ends of the lobes were free, the lobes tended to lie flat against the substrate, thereby defeating the sought-for three-dimensional effect.

In an effort to remedy this, two additional patents have issued. Significantly, both of those patents utilize the material, apparatus, and method of the aforementioned '320 and '375 patents. The later patents are U.S. Pat. No. 5,281,451 to James R. Reynolds and U.S. Pat. No. 5,486,385 to Don M. Bylund et al. In the '451 patent, a camouflage construction is formed having an open mesh net substrate, and a continuous sheet overlying the substrate and bonded thereto along plural spaced lines of attachment. The sheet is cut on opposite sides of the lines of attachment to form a plurality of lobes. The fabric is heated and the lobes folded and creased to increase the openness of the fabric.

The fabric of the '385 patent is an open mesh, net substrate to which is bonded a sheet material. The sheet is colored in the desired pattern and bonded to the substrate along spaced lines of attachment. Separate lobes are formed on each side of the lines of stitching (attachment) to simulate the appearance of natural objects of the terrain. The lobes are then heated to over 400° F. to wrinkle and de-luster the camouflage lobes to increase the three-dimensional effect and significantly decrease luster.

It is significant to note that, in all four of the aforementioned patents, the construction has an open mesh net substrate and a continuous sheet overlying the substrate and bonded thereto along plural spaced lines of attachment. The sheet is then cut on opposite sides of the lines of attachment to form a plurality of lobes.

Notwithstanding the efforts shown in the aforementioned four patents in forming a composition that has a three-dimensional effect, there is still a need in the industry for camouflaged fabric having a definite and naturally appearing three-dimensional effect.

### SUMMARY OF THE INVENTION

The present invention substantially meets the aforementioned needs of the industry. A definite three-dimensional effect is created without the need to heat, fold, or crease the material that is applied to the substrate. The three-dimensional effect is created simply by the means by which individual strips are adhered to the substrate. With the method of the present invention, there is no need for the complex machine necessary for stitching and cutting as disclosed in the '320 and '375 patents noted above.

The present invention is a composite camouflage composition that includes a substrate and a plurality of individual strips of camouflage material being spaced apart and adhered to the substrate along a bonding axis, each strip of the plurality of individual strips of camouflage material presenting a plurality of lobes adjacent the bonding axis, each strip of the plurality of individual strips of camouflage material being gathered at points along the bonding axis such that more than one layer of each strip of the plurality of individual strips of camouflage material is adhered to the substrate at such points. The present invention is further a garment and a method of forming the camouflage composition.

### BRIEF DESCRIPTION OF THE DRAWINGS

FIG. 1 is perspective view of a swatch of material made in accordance with the present invention having four strips of camouflage material adhered to a substrate;

FIG. 2 is perspective view of the swatch of material of FIG. 1 with a fifth strip of camouflage material being adhered to a substrate, a first portion of the fifth strip being adhered and a second portion of the fifth strip not being adhered;

FIG. 3 is perspective view of the swatch of material of FIG. 1 with the fifth strip of camouflage material adhered to a substrate and the length of the fifth strip being depicted in phantom;

FIG. 4 is and enlarged perspective view of a portion of the swatch of material of FIG. 1 with a fifth strip of camouflage material being adhered to a substrate, a first portion of the fifth strip being adhered and a second portion of the fifth strip not being adhered;

FIG. 5 is a sectional taken along the section line 5-5 of FIG. 4;

FIG. 6 is a sectional taken along the section line 6-6 of FIG. 4;

FIG. 7 is a front elevational view of an exemplary garment, a portion of which is made of material made in accordance with the present invention; and

FIG. 8 is a planform depiction of an individual strip having a Mossy Oak^{R} camouflage imprint.

### DETAILED DESCRIPTION OF THE DRAWINGS

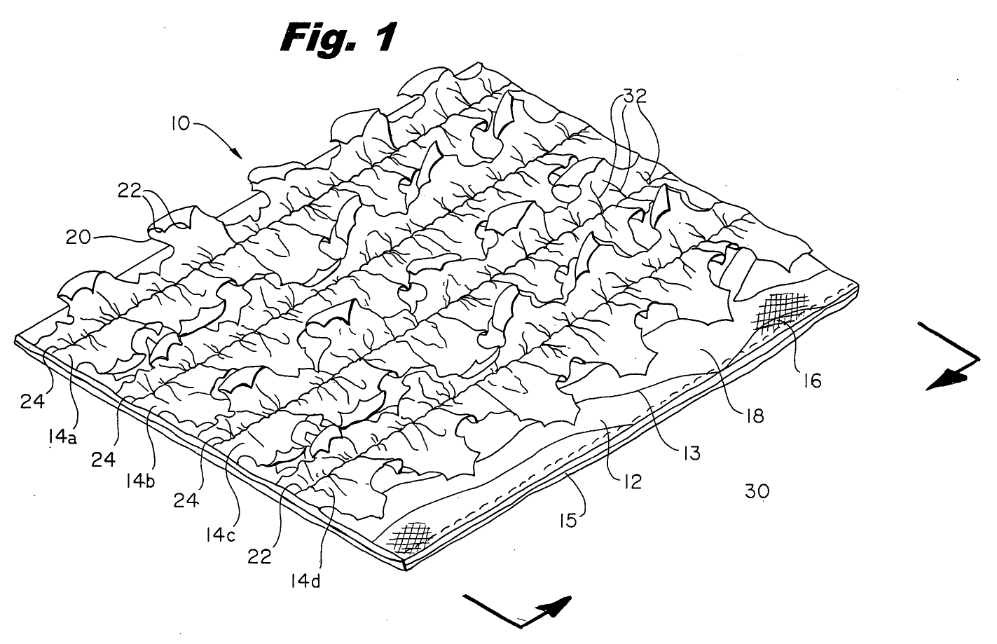

The camouflage composition of the present invention is shown generally at 10 in the Figures. Composition 10 has two major components; substrate 12 and individual strips 14. The substrate 12 preferably has a relatively small mesh 16 although the substrate 12 could be a closed material as well, including being closely woven. The size of the mesh 16 is discernible by the unaided human eye, and is large enough to accommodate the free passage of air through the substrate 12, while at the same time forming a barrier for many noisome insects, including flies, mosquitoes, and ticks. A somewhat smaller mesh 16 may also be selected such that water vapor, including human perspiration, may pass through the substrate 12, but that water droplets, as from rain, melting snow, and the like, does not pass through the substrate 12. For a given quantity of the composition 10, it is preferable that the substrate 12 be a single contiguous piece of material. In certain applications, such as covering vehicles and the like, individual pieces of the substrate 12 maybe joined together to form a large sheet. The substrate 12 may be formed of any suitable textile yarn, such as nylon, polyester, or the like. The substrate 12 may be dyed a single color or may be imprinted with a camouflage pattern 13 having a plurality of colors in selected patterns, as depicted in FIG. 1.

The substrate 12 may overly base 15. The base 15 may be an insulating layer or the like. Preferably, the base 15 is put in place after the individual strips 14 are adhered to the substrate 12.

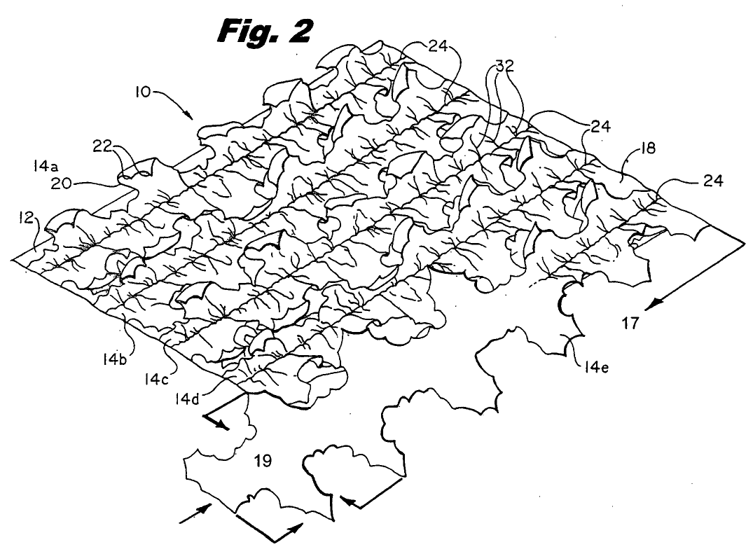

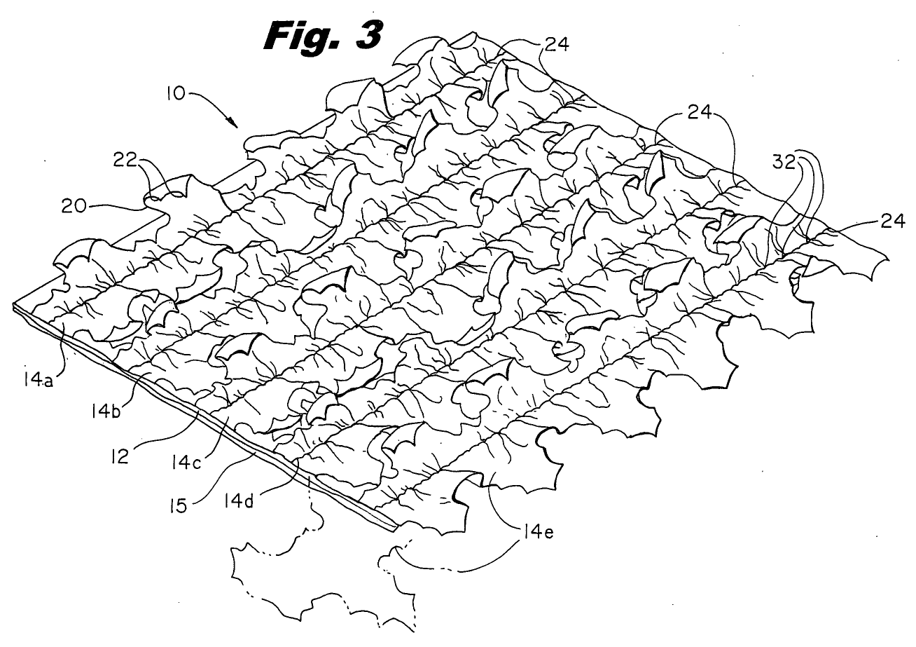

The individual strips 14, as depicted in FIG. 8, may be formed of a suitable material, such as woven nylon or polyester fabric, preferably of rip-stop construction. Each of the individual strips 14 has a length dimension 15 and a width dimension 17, with the length dimension 15 being substantially greater than width dimension 17. See FIG. 2. A camouflage pattern imprint 18 is imposed on each of the individual strips 14. The camouflage pattern imprint 18 may be selected from any of a number of well-known patterns currently in the marketplace, or an original pattern may be designed to comprise the camouflage pattern imprint 18.

A plurality of opposed lobes 20 are formed on the individual strips 14 and from lobe tip to opposed lobe tip comprise the width dimension 15 of the individual strips 14. The width dimension 15 of the individual strips 14 is preferably between about two and five inches from the tip of a lobe 20 to the tip of an opposed lobe 20. Preferably, the opposed lobes 20 extend along the full length dimension 17 of the individual strips 14.

In an alternative embodiment, the individual strips 14 can have a substantially straight margin on one side, and a plurality of lobes 20 formed in opposition thereto. In such case, the individual strips 14 would preferably be bonded to the substrate 12 proximate the straight side margin.

Preferably, each of the lobes 20 has a plurality of sub-lobes 22 formed thereon. The sub-lobes 22 are selected such that the lobe 20 assumes the appearance of a leaf, preferably in the shape of an oak or maple leaf.

Each of the individual strips 14 has a generally centrally located bonding axis 24. In the depiction of the figures, the bonding axis 24 is formed in a generally straight line. Alternatively, the bonding axis 24 could be undulating or generally sinusoidal. The generally sinusoidal bonding axis 24 provides for different-sized lobes 20 on either sides of the undulations of the generally sinusoidal bonding axis 24 to enhance the 3-D effect.

As depicted in the Figures, the bonding axes 24 of adjacent individual strips 14a-e are selected to be spaced apart. In the Figures, the straight bonding axes 24 of adjacent strips 14 are generally parallel with one another. The spacing between the bonding axes 24 of adjacent individual strips 14 is preferably selected to be less than one-half the width 15 of the individual strips 14, so as to provide a certain amount of overlap of the facing lobes 20 on adjacent strips 14.

A bond 26 is formed along the bonding axis 24. Such a bond 26 may be made with adhesive or heat, but is preferably formed by stitching. The length dimension 17 along the bonding axis 24 is selected to be substantially greater than the dimension 30 of the substrate 12 which will be coterminous with the individual strips 14. Preferably, the ratio of the length dimension 30 of the substrate 12 to the length dimension 17 of the individual strips 14 is from about 1:1.1 to about 1:1.75 and is most preferably substantially 1:1.3. The reason for the disparity between the length dimensions 17, 30 will become apparent when the method of adhering the individual strips 14 to the substrate 12 is described in greater detail below.

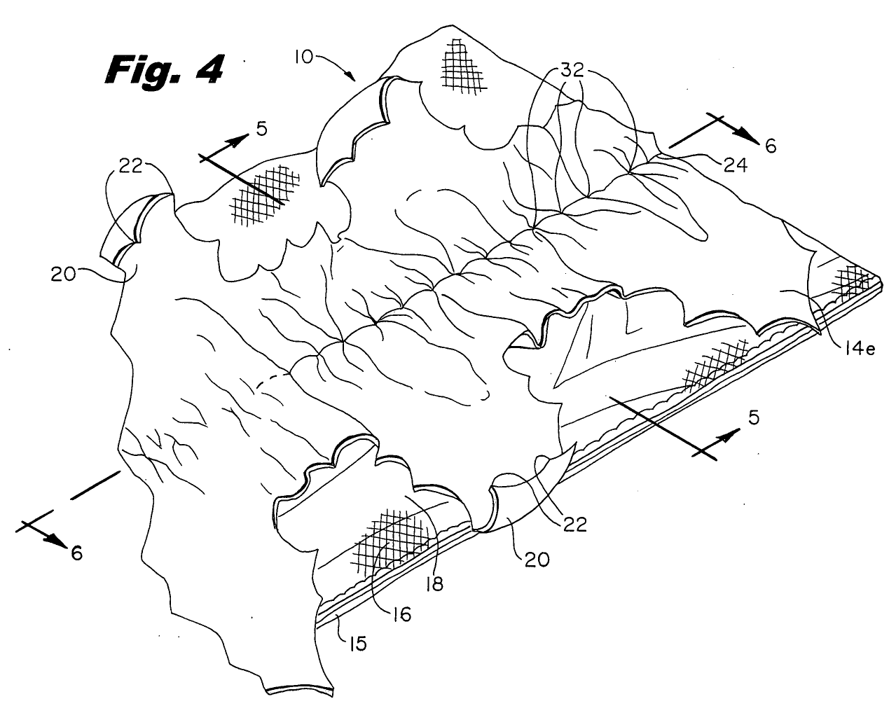

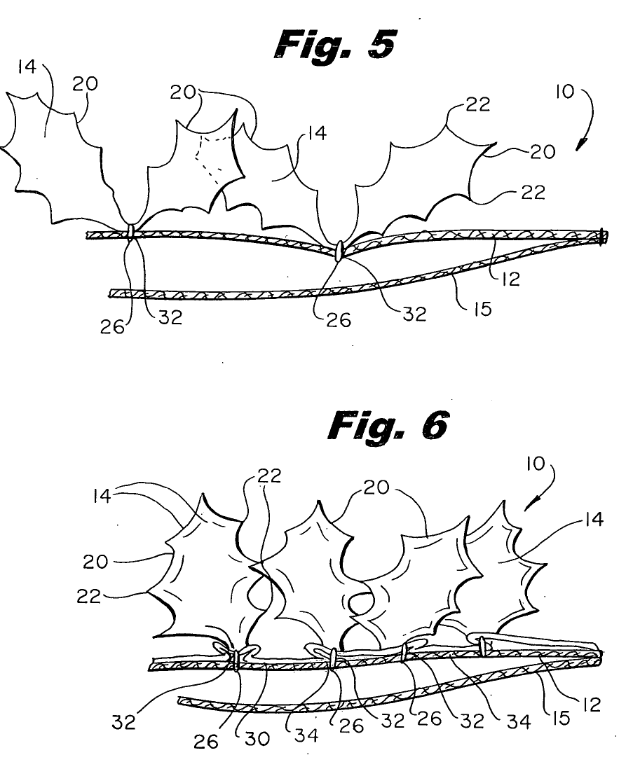

Effectively, a plurality of spaced-apart gather points 32 are defined along the bond 26. See FIGS. 4-6. At each gather point 32, the individual strip 14 is gathered such that the individual strip 14 is drawn into small folds or puckers. The small folds or puckers are effected as by drawing a thread through the individual strip 14 or by other suitable bonding techniques. The gather 34 that occurs at the gather points 32 results in more than one layer of the individual strip 14 being bonded to the substrate 12. It The gather points 32 may be uniformly spaced or may be randomly spaced apart. The random spacing of the gather points 32 generates a more non-uniform appearance to the three-dimensional camouflage composition 10, which is a desirable feature. The gathering of the individual strips 14 as they are bonded to the substrate 12 advantageously causes the lobes 20 to fold and separate from or stand out from the substrate 12 without any additional steps to deform the lobes 20 as noted in the '451 and '385 patents discussed above.

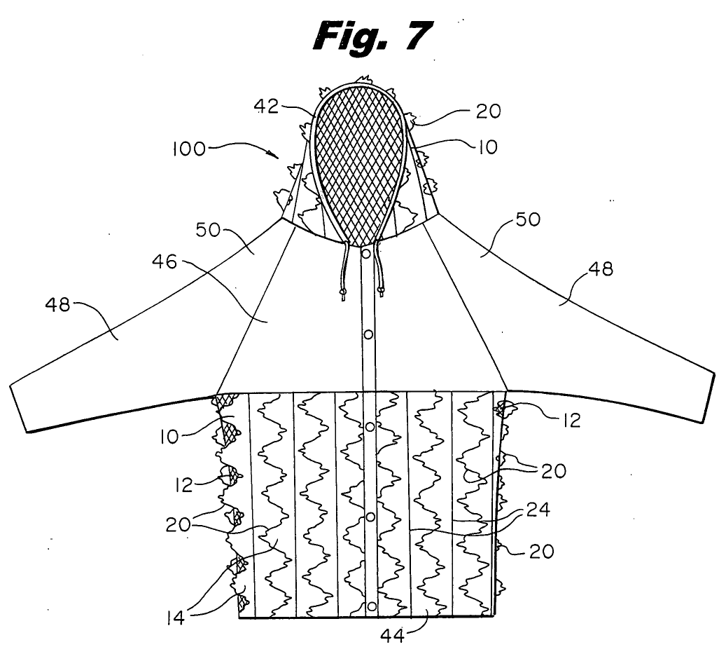

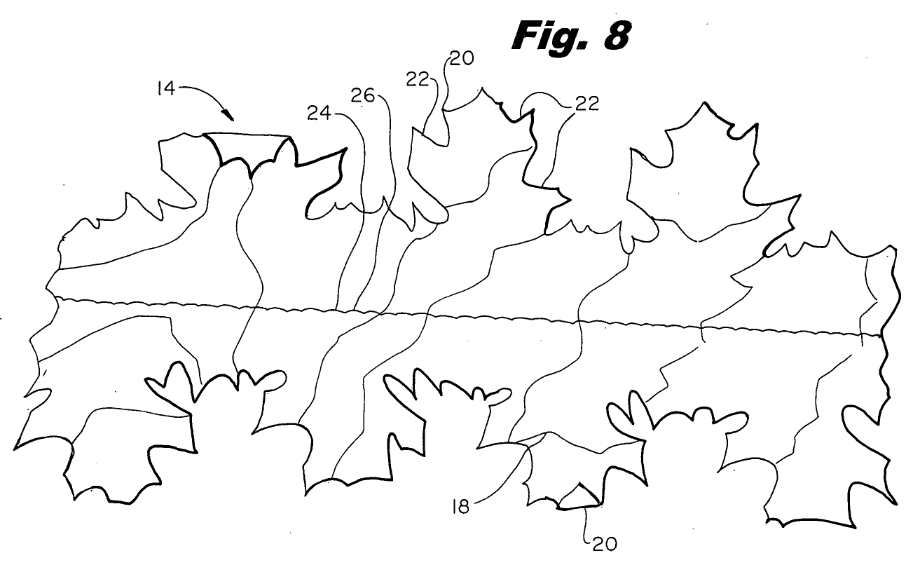

The camouflage composition 10 may be formed into a plurality of different garments including, but not limited to: jackets, pullovers, parkas, coveralls, bibs, and pants. The camouflage composition 10 may be formed into a portion of a garment 100 made in accordance with the teachings of U.S. Pat. No. 5,695,835, owned by the assignee of the present application and incorporated herein by reference, as depicted in FIG. 7, or may form the entire garment. The garment 100 has the hood 42 and the torso 44 made of the camouflage composition 10 of the present invention. The chest 46 and the front facing arms 48 are made of a two dimensional material 50 that may have a camouflage design imprinted thereon.

It will be obvious to those skilled in the art that other embodiments in addition to the ones described herein are indicated to be within the scope and breadth of the present application. Accordingly, the applicant intends to be limited only by the claims appended hereto.

1-43. (canceled)

44. A multi-layered camouflage construction comprising:
a first textile substrate, said first textile substrate having a first end and a second end,
a second textile substrate overlying said first textile substrate, said second textile substrate being secured to said first textile substrate along multiple lines of attachment, said multiple lines of attachment extending from said first end to said second end of said first textile substrate, said second textile substrate further comprising a plurality of lobes extending in a transverse direction to said multiple lines of attachment, at least one of said lobes having a base portion attached to said first textile substrate along one of said multiple lines of attachment and an outer wrinkled end portion free from said first textile substrate, said lobes being adapted to simulate the appearance of natural objects of a terrain, and
a gathered seam provided along the length of at least one of said multiple lines of attachment, said seam comprising a thread configured for securing said multiple line of attachment, said second textile substrate being gathered along said seam.

45. The camouflage construction of claim 44 wherein said first textile substrate comprises an open mesh net substrate.

46. The camouflage construction of claim 45 wherein said open mesh net substrate facilitates the movement of air through said camouflage construction.

47. The camouflage construction of claim 45 wherein said open mesh net substrate includes a camouflaged print pattern.

48. The camouflage construction of claim 45 wherein said open mesh net substrate is comprised of a material selected from the following materials: nylon, polypropylene, polyester, or any combination thereof.

49. The construction of claim 44 wherein a defined spacing is provided between said multiple lines of attachment, said spacing being between about 1 and about 5 inches.

50. The camouflage construction of claim 44 in which said seam provides said thread in a sewn stitch.

51. In an article of manufacture, a camouflage construction having first textile substrate connected to a second textile substrate along multiple stitched lines of attachment, said multiple stitched lines of attachment comprising a plurality of seams, said seams comprising gathered portions of said second textile substrate along the length of said second textile substrate, said gathered portions forming a three-dimensional appearance in said second textile substrate, said seams further comprising a first thread, said second textile substrate further comprising a plurality of lobes extending in a transverse direction to said multiple lines of attachment, at least one of said lobes having a base portion attached to said first textile substrate along one of said multiple lines of attachment and an outer wrinkled end portion free from said first textile substrate, said lobes being adapted to simulate the appearance of natural objects of a terrain.

52. The article of claim 51 wherein said first textile substrate comprises an open mesh net substrate.

53. The article of claim 52 wherein said open mesh net substrate includes a camouflaged print pattern.

54. The article of claim 52 wherein said open mesh net substrate is comprised of nylon, a polyester, or any combination thereof.

55. The article of claim 51 wherein a defined spacing is provided between said multiple lines of attachment, said spacing being between about 1 and about 5 inches.

56. A composite camouflage composition, comprising:
a substrate;
a plurality of individual strips of camouflage material being spaced apart and adhered to the substrate along a bonding axis, each strip of the plurality of individual strips of camouflage material presenting a plurality of lobes adjacent the bonding axis, each strip of the plurality of individual strips of camouflage material being gathered at points along the bonding axis such that more than one layer of each strip of the plurality of individual strips of camouflage material is adhered to the substrate at such points.

57. The composite camouflage composition of claim 56, the substrate bearing the imprint of a camouflage pattern.

58. The composite camouflage composition of claim 56, the lobes of each strip of the plurality of individual strips of camouflage material being formed in a substantially leaf shaped pattern.

59. The composite camouflage composition of claim 56, each strip of the plurality of individual strips of camouflage material being adhered to the substrate along a bonding axis by stitches.

60. The composite camouflage composition of claim 56, the substrate being an open mesh.

61. The composite camouflage composition of claim 56, the substrate being pervious to water vapor and impervious to water droplets.

62. The composite camouflage composition of claim 56, the lobes of each strip of the plurality of individual strips of camouflage material standing off from the substrate.

63. The composite camouflage composition of claim 56, each strip of the plurality of individual strips of camouflage material having a length dimension prior to being adhered to the bonding axis that is between about 1.1 and 1.75 times the length dimension of the substrate to which the individual strip is adhered.

64. The composite camouflage composition of claim 56, the bonding axes of adjacent strips being spaced apart between one and three inches.

65. A garment being formed at least in part of the composition of claim 56.
